(19) United States
(12) Patent Application Publication
(10) Pub. No.: US 2017/0213150 A1
(43) Pub. Date: Jul. 27, 2017

(54) REINFORCEMENT LEARNING USING A PARTITIONED INPUT STATE SPACE

(71) Applicant: Osaro, Inc., San Francisco, CA (US)

(72) Inventors: Itamar Arel, Knoxville, TN (US); Michael Kahane, San Francisco, CA (US); Khashayar Rohanimanesh, San Francisco, CA (US)

(73) Assignee: Osaro, Inc., San Francisco, CA (US)

(21) Appl. No.: 15/206,101

(22) Filed: Jul. 8, 2016

Related U.S. Application Data
(60) Provisional application No. 62/286,856, filed on Jan. 25, 2016.

(51) Int. Cl. G06N 99/00; G06N 5/04

(52) U.S. Cl. CPC G06N 99/005; G06N 5/043

(57) ABSTRACT

Methods, systems, and apparatus, including computer programs encoded on computer storage media, for reinforcement learning using a partitioned reinforcement learning input state space (RL input state space). One of the methods includes maintaining data defining a plurality of partitions of a space of reinforcement learning (RL) input states, each partition corresponding to a respective supervised learning model; obtaining a current state representation that represents a current state of the environment; for the current state representation and for each action in the set of actions, identifying a respective partition and processing the action and the current state representation using the supervised learning model that corresponds to the respective partition to generate a respective current value function estimate; and selecting an action to be performed by the computer-implemented agent in response to the current state representation using the respective current value function estimates.

### BACKGROUND

This specification relates to reinforcement learning systems.

In a reinforcement learning system, an agent interacts with an environment by receiving an observation that either fully or partially characterizes the current state of the environment, and in response, performing an action selected from a predetermined set of actions. The reinforcement learning system receives rewards from the environment in response to the agent performing actions and selects the action to be performed by the agent in response to receiving a given observation in accordance with an output of a value function representation. For example, some value function representations take as an input an observation and an action and output a numerical value that is an estimate of the expected rewards resulting from the agent performing the action in response to the observation.

### SUMMARY

This specification describes technologies that relate to partitioning a reinforcement learning input state (RL input state) space and selecting actions to be performed by an agent interacting with the environment using the partitioned RL input state space.

In general, one innovative aspect of the subject matter described in this specification can be embodied in methods of selecting an action to be performed by a computer-implemented agent that interacts with an environment by performing actions selected from a set of actions. One of the methods includes maintaining data defining a plurality of partitions of a space of reinforcement learning (RL) input states, each partition corresponding to a respective supervised learning model that is configured to receive a state representation and an action from the set of actions and to process the received state representation and the received action to generate a respective value function estimate that is an estimate of a return resulting from the computer-implemented agent performing the received action in response to the received state representation; obtaining a current state representation that represents a current state of the environment; for the current state representation and for each action in the set of actions, identifying a respective partition and processing the action and the current state representation using the supervised learning model that corresponds to the respective partition to generate a respective current value function estimate; and selecting an action to be performed by the computer-implemented agent in response to the current state representation using the respective current value function estimates.

In general, another innovative aspect of the subject matter described in this specification can be embodied in methods of determining a final partitioning of a space of reinforcement learning (RL) input states, each partition in the final partitioning corresponding to a respective supervised learning model of a plurality of supervised learning models that is configured to receive a state representation and an action from a set of actions and generate a respective value function estimate. One of the methods includes obtaining data defining a current partitioning of the space of RL input states, each partition in the current partitioning corresponding to a respective supervised learning model of the plurality of supervised learning models; obtaining a sequence of state representations representing states of an environment and, for each state representation in the sequence, an action selected to be performed by the computer-implemented agent in response to the state representation and a value function estimate, the value function estimate being an estimate of a return resulting from a computer-implemented agent performing the selected action in response to the state representation; obtaining, for each state representation in the sequence, an actual return resulting from the computer-implemented agent performing the selected action; determining, from the actual returns and the value function estimates, that a performance of the plurality of supervised learning models has become unacceptable as of a particular state representation in the sequence and, in response: modifying the current partitioning of the space of RL input states to add a new partition; and initializing a new supervised learning model that corresponds to the new partition.

Other embodiments of these aspects include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Undesirable effects associated with catastrophic forgetting during training of supervised learning models used to select actions to be performed by an agent interacting with an environment can be mitigated in a scalable manner. The supervised learning models can be trained in a scalable manner to effectively select actions in response to new state representations without adversely affecting their performance when the environment is in other states.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for selecting an action to be performed by an agent using a partitioned RL input state space.

FIG. 3 is a flow diagram of an example process for adjusting a current partitioning of a space of RL input states.

FIG. 4 is a flow diagram of an example process for determining an initial partitioning of a space of RL input states using imitation learning.

Like reference numbers and designations in the various drawings indicate like elements.

### DETAILED DESCRIPTION

This specification generally describes a reinforcement learning system that selects actions to be performed by an agent interacting with an environment.

In some implementations, the environment is a virtualized environment that changes state in response to received user inputs. For example, the environment may be an executing video game. In these implementations, the agent may be a simulated user, i.e., the agent may be a computer program that interacts with the virtualized environment by providing simulated user inputs to the virtualized environment that cause the virtualized environment to transition from one state to another.

In some other implementations, the environment is a real-world environment. For example, the agent may be a robot attempting to complete a specified task and the environment may be the surroundings of the robot as characterized by data captured by one or more sensory input devices of the robot. Example tasks may include assembly tasks performed by industrial robots which may involve grasping and manipulation of objects within a given space of operation.

The reinforcement learning system receives data that partially or fully characterizes the current state of the environment and uses the received data to select an action from the set of actions to be performed by the agent in response to the received data. For example, when the environment is a video game, the data may be an image of the current state of the video game as displayed on a display device or data generated by processing the image. As another example, when the environment is a real-world environment, the data may be an image or video captured by an input device of a robot interacting with the real-world environment or data generated by processing the image or video. Data received by the reinforcement learning that partially or fully characterizes a state of an environment will be referred to in this specification as an observation.

Generally, which actions are in the set of actions are fixed prior to any given action selection performed by the reinforcement learning system. Thus, in response to any given observation, the system selects the action to be performed by the agent in response to the observation from a predetermined set of actions. In some cases, however, which actions are in the set of actions may be adjusted before the system processes a given observation, e.g., to add a new action to the set or to remove an existing action from the set.

In response to the agent performing the selected action and the environment transitioning into a new state, the reinforcement learning system receives a reward. Generally, the reward is a numeric value that is received from the environment as it transitions into a given state and is a function of the state of the environment. While the agent is interacting with the environment, the reinforcement learning system selects actions to be performed by the agent in order to maximize the expected return. Generally, the expected return is a function of the rewards anticipated to be received over time in response to future actions performed by the agent. That is, the return is a function of future rewards received starting from the immediate reward received in response to the agent performing the selected action. For example, possible definitions of return that the reinforcement learning system attempts to maximize may include a sum of the future rewards, a discounted sum of the future rewards, or an average of the future rewards.

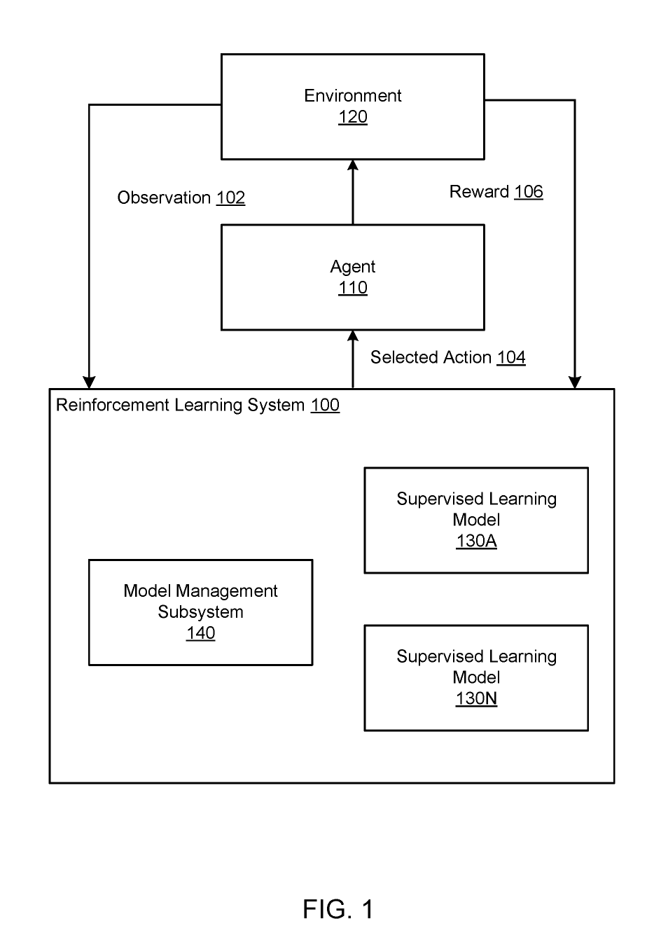

FIG. 1 shows an example reinforcement learning system 100. The reinforcement learning system 100 is an example of a system implemented as one or more computer programs on one or more computers in one or more locations in which the systems, components, and techniques described below are implemented.

The reinforcement learning system 100 selects actions to be performed by an agent 110 that interacts with an environment 120. In particular, the reinforcement learning system 100 receives an observation 102 characterizing a current state of the environment 120 and uses one of multiple supervised learning models 130A-130N to select an action 104 to be performed by the agent 110 in response to the received observation 102.

As described above, in some implementations, the environment 120 is a real-world environment. In some of these implementations, the reinforcement learning system 100 may be implemented as one or more computer programs on one or more computers embedded in a mechanical agent interacting with the environment 120. For example, the mechanical agent may be a semi- or fully-autonomous vehicle, watercraft, or aircraft or an underwater, on land, in the air, in space, or industrial robot.

Additionally, as described above, in some implementations, the environment 120 is a virtualized environment and the agent is a computer program that interacts with the virtualized environment. In some of these implementations, the reinforcement learning system 100 may be implemented as one or more computer programs on the same computer or computers as the agent.

Each of the supervised learning models 130A-N is a machine learning model and, more specifically, a supervised learning model, e.g., a deep neural network or a support vector machine, that is configured to receive as input a state representation for an environment state and an action from the set of actions and to output a value function estimate for the state-action pair. The value function estimate for a state-action pair is an estimate of the return resulting from the agent performing the input action in response to an observation characterizing the state of the environment 120. In some implementations, each of the supervised learning model 130A-N has the same model architecture, with possibly different values of the parameter

Generally, the reinforcement learning system 100 derives the state representation for a given state from the received observation that characterizes the given state. A state representation is generally a vector or other ordered collection of values that represents a given state.

In some implementations, the state representation for a given state is the observation received by the reinforcement learning system 100 that characterizes the given state.

In some other implementations, the reinforcement learning system 100 combines the current observation with one or more recent observations to generate the state representation. For example, the state representation can be a stack of the observation and a number of most recent observations in the order in which they were received by the reinforcement learning system 100 or a compressed representation of the observation and the most recent observations.

In yet other implementations, to generate the state representation, the system uses a neural network, e.g., a recurrent neural network, that is configured to receive an observation and an action and to predict the next state of the environment, i.e., to predict the next state that the environment will transition to if the agent performs the received action. In particular, in these implementations, the system can use some or all of the activations of one of the hidden layers of this neural network as the state representation.

The reinforcement learning system 100 maintains data defining a partitioning of the space of RL input states into multiple partitions. Generally, an RL input state is all of or a portion of the input to one of the supervised learning models 130A-130N. In particular, in some implementations, the space of RL input states is the space of possible state representations representing states of the environment, i.e., of possible state representation vectors that make up part of the input to the supervised learning models. In some other implementations, the space of RL input states is the space of possible combinations of state representations and actions, i.e., the space of possible combinations, e.g., concatenations, of state representation vectors and vectors representing actions in the set of actions.

Each of the supervised learning models 130A-130N corresponds to a different one of the multiple partitions, with each partition having a corresponding supervised learning model, i.e., the number of supervised learning models 130A-130N is the same as the number of partitions in the partitioning of the RL input state space.

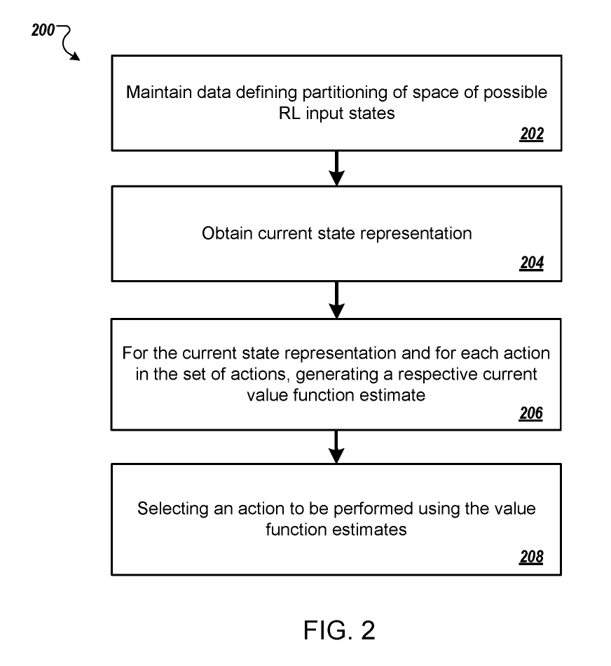

When the reinforcement learning system 100 receives the observation 102, the reinforcement learning system 100 generates a state representation from the observation 102 and, for each action in the set of actions, identifies a respective partition of the RL input state space. The reinforcement learning system 100 then processes the action and the current state representation using the supervised learning model that corresponds to the respective partition identified for the action to generate a respective value function estimate for the action and uses the value function estimates to select the action 104 to be performed by the agent 110. Selecting an action to be performed is described in more detail below with reference to FIG. 2.

The reinforcement learning system 100 performs a reinforcement learning process to determine a final partitioning of the space of RL input space and to determine trained values of the parameters of the supervised learning models that correspond to the partitions in the final partitioning.

In particular, if the reinforcement learning system receives the observation 102 during the learning process, once the agent 110 has performed the selected action 104, the reinforcement learning system 100 identifies a reward 106 resulting from the agent 110 performing the selected action 104. The reward 106 is an immediate actual reward resulting from the agent 110 performing the selected action 104 in response to the observation 102.

The reinforcement learning system 100 then uses the reward 106 to update the current values of the parameters of the supervised learning model that corresponds to the respective partition identified for the selected action 104, i.e., the supervised learning model that was used to generate the value function estimate for the selected action 104. The reinforcement learning system 100 can update the parameter values, e.g., using conventional reinforcement learning techniques.

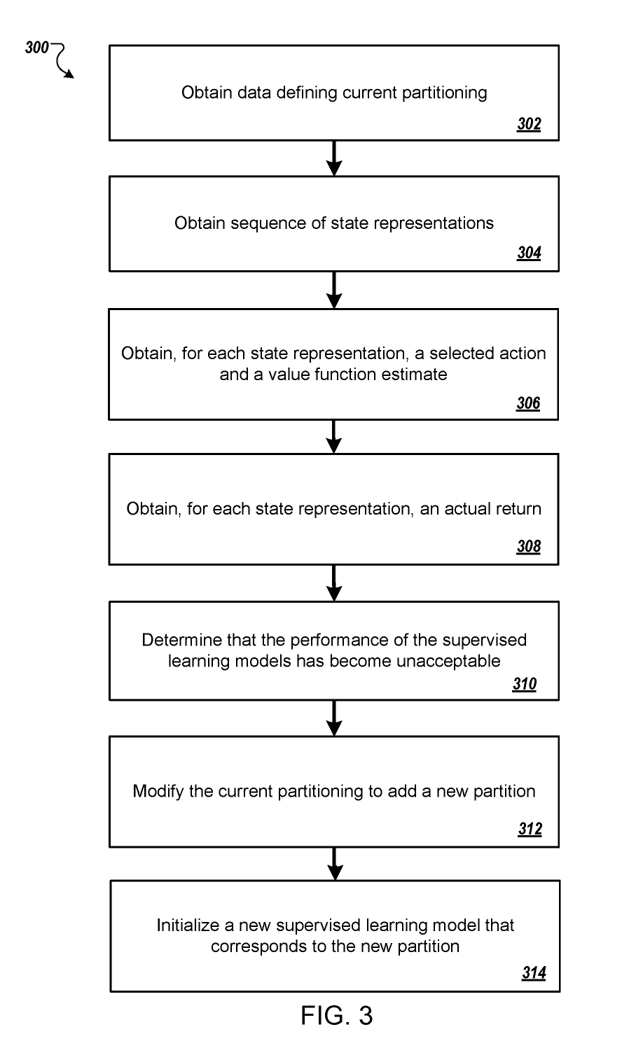

Additionally, the reinforcement learning system 100 includes a model management subsystem 140 that generates an initial partitioning of the RL input state space and then, during the learning process, updates the partitioning until a final partitioning of the RL input state space is determined. In particular, at any given time during the learning process, the model management subsystem 140 monitors the performance of the supervised learning models that correspond to the partitions in a current partitioning of the RL input state space and determines whether to add a new partition to the current partitioning based on whether or not the performance of the models is acceptable. Adjusting a current partitioning is described in more detail below with reference to FIG. 3.

FIG. 2 is a flow diagram of an example process 200 for selecting an action to be performed by an agent using a partitioned RL input state space. For convenience, the process 200 will be described as being performed by a system of one or more computers located in one or more locations. For example, a reinforcement learning system, e.g., the reinforcement learning system 100 of FIG. 1, appropriately programmed, can perform the process 200.

The system maintains data defining a partitioning of the space of possible RL input states into multiple partitions (step 202). In particular, the data is data identifying a set of centroids, with each centroid being a point in the space of possible RL input states, i.e., being a possible RL input state. Each centroid defines a respective partition, with each RL input state that is closer to the centroid than to any of the other centroids being in the partition defined by the centroid.

The system obtains a current state representation that represents a current state of the environment (step 204). That is, the system receives a current observation characterizing the current state of the environment and, in some implementations, uses the current observation as the current state representation. In some other implementations, the system combines the current observation with one or more recently received observations to generate the current state representation.

For the current state representation and for each action in the set of action, the system generates a respective current value function estimate by identifying a partition for the action and then processing the current state representation and the action using the supervised learning model corresponding to the partition (step 206).

When the RL input space is the space of possible state representations, the system determines the partition to which the current state representation belongs and then uses the supervised learning model that corresponds to the partition to generate the respective current value function estimate for all of the actions, i.e., the system identifies the same supervised learning model for each action in the set of actions.

When the RL input space is the space of possible combinations of state representations and actions, for each action, the system combines the current state representation with the action and determines the partition to which the state representation-action combination belongs and then uses the supervised learning model that corresponds to the partition to generate the respective current value function estimate for the state representation-action combination. In these implementations, the system may use different supervised learning models to generate the current value function estimates for different current state representation-action combinations, i.e., if the different current state representation-action combinations belong to different partitions of the RL input state space.

To determine the partition to which an RL input state, i.e., a current state representation or a current state representation-action combination, belongs, the system determines the centroid that is closest to the RL input state. The system then identifies the partition that is defined by the closest centroid as the partition to which the RL input state belongs. For example, the system may determine that the centroid that has the highest cosine similarity with the RL input state or the smallest Euclidean distance to the RL input state of any of the centroids identified in the data maintained by the system is the closest centroid to the RL input state.

The system selects an action to be performed using the value function estimates (step 208).

In some cases, e.g., after the learning process has been completed, i.e., after trained values of the parameters of each of the models have been determined and the partitioning of the space of possible RL input states is final, the system selects the action that has the highest value function estimate.

In some other cases, e.g., during the learning process, i.e., while determining trained values of the parameters of the supervised learning models, while determining the final partitioning of the space of possible RL input states, or both, the system may select an action other than the action that has the highest value function estimate.

For example, the system may select an action randomly from the set of actions with probability ε and select the action having the highest value function estimate with probability 1-ε, where ε is a constant between zero and one.

As another example, during learning, the system may use a confidence function representation to adjust the value function estimates before using the estimates to select the action to be performed by the agent. In particular, for each value function estimate, the system generates a confidence score in accordance with the confidence function representation. The confidence score is a measure of confidence that the corresponding value function estimate is an accurate estimate of the return that will result from the agent performing the corresponding action in response to the current observation. Confidence function representations and adjusting value function estimates is described in more detail in U.S. patent application Ser. No. 14/952,540, entitled REINFORCEMENT LEARNING USING CONFIDENCE SCORES, and filed on Nov. 25, 2015, the entire contents of which are hereby incorporated by reference herein in their entirety. Once the value function estimates have been adjusted, the system uses the adjusted value function estimates to select the action to be performed, e.g., by selecting the action with the highest adjusted value function estimate or by selecting an action randomly from the set of actions with probability ε and selecting the action having the highest adjusted value function estimate with probability 1-ε.

In some implementations, when the process 200 is performed during learning, i.e., while training the supervised learning models to determine the trained values of the parameters of the models, the system maintains a maturity value for each model that corresponds to one of the partitions of the space. The maturity value for a given model reflects how mature the model is, i.e., how many updates have already been applied to the values of the parameters of the model during the learning process. For example, the maturity value M for a given model may satisfy:

M=1−(1−λ)ⁿ,

where n is the number of updates that have been applied to the values of the parameters of the model during the training and λ is a constant value between zero and one, exclusive. In these implementations, the system may adjust the temporal difference learning error used to update the parameters of the model corresponding to the partition identified for the selected action based on the maturity value of the model, e.g., by multiplying the temporal difference learning error by the maturity values, prior to using the temporal difference learning error as the target error to determine the model parameter updates using the conventional reinforcement learning technique.

As described above, during the learning process, the system can adjust the partitioning of the space of possible RL input states, i.e., to add and, optionally, remove partitions from the partitioning.

In particular, the system generates an initial partitioning of the space that is then adjusted by the system during the learning process. In some implementations, the system generates the initial partitioning by assigning a single supervised learning model to correspond to the entire space. In some other implementations, the system generates the initial partitioning by initializing each of multiple centroids at random points in the RL input state space and initializing a respective supervised learning model to correspond to each of the multiple centroids.

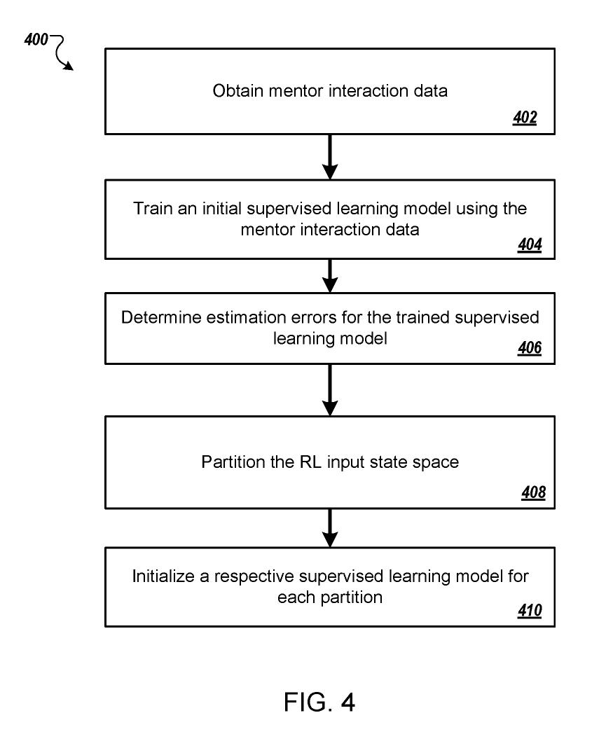

In some other implementations, the system generates the initial partitioning of the space using an imitation learning technique. That is, the system obtains data representing interactions with the environment by a different entity, e.g., a human user or a different agent, and determines the initial partitioning of the space using the obtained data. Determining an initial partitioning of the space using an imitation learning technique is described below with reference to FIG. 4.

FIG. 3 is a flow diagram of an example process 300 for adjusting a current partitioning of a space of RL input states. For convenience, the process 300 will be described as being performed by a system of one or more computers located in one or more locations. For example, a reinforcement learning system, e.g., the reinforcement learning system 100 of FIG. 1, appropriately programmed, can perform the process 300.

The system obtains data defining a current partitioning of the space of RL input states (step 302). That is, the system obtains data identifying the current set of centroids that define the current partitioning of the space of RL input states.

The system obtains a sequence of state representations (step 304). In particular, the sequence of state representations is a sequence, e.g., a temporal sequence, of state representations obtained by the system as a result of the agent interacting with the environment during the learning process.

The system obtains, for each state representation in the sequence, a selected action and a value function estimate (step 306). The selected action is the action that was selected by the system to be performed by the agent in response to the state representation, e.g., by performing the process 200, and the value function estimate is the value function estimate generated by one of the supervised learning models that correspond to the partitions in the current partitioning as part of determining which action to select in response to the state representation. In particular, the value function estimate is an estimate of the return that would result from the agent performing the selected action in response to the state representation.

The system obtains, for each state representation, an actual return that resulted from the agent performing the selected action in response to the state representation (step 308). In some implementations, the system tracks the rewards received as a result of performing the selected action and as a result of performing each action performed subsequent to the selected action and determines the actual return from the tracked rewards. In some other implementations, the system receives the actual return from an external system.

The system determines that, as of a particular state representation and from the value function estimates and the actual returns, the performance of the supervised learning models that correspond to the partitions in the current partitioning has become unacceptable (step 310).

In particular, the system can check whether the performance of the supervised learning models is acceptable at specified intervals in the sequence, e.g., as of every sequence representation, as of every tenth sequence representation, or every fiftieth sequence representation in the sequence.

The system can measure the performance of the supervised learning models as of a given sequence representation based on estimation errors between the value function estimates and the actual returns for the state representations before the given state representation in the sequence. The estimation error may be the difference between the value function estimate and the actual return, the square of the difference between the value function estimate and the actual return, or any other appropriate machine learning error measure for the models.

The system can determine that the performance of the models has become unacceptable in any of a variety of ways.

For example, the system can determine that the performance has become unacceptable when, as of a particular state representation in the sequence, a running average of the estimation error for the state representations before the particular state representation in the sequence has exceeded a predetermined threshold average value.

As another example, the system can determine that the performance has become unacceptable when, as of a particular state representation in the sequence, the number of estimation errors that have exceeded a predetermined threshold error value exceeds a predetermined threshold number.

As another example, the system can determine that the performance has become unacceptable when, as of a particular state representation in the sequence, the standard deviation of the estimation errors has exceeded a predetermined threshold deviation.

Other appropriate measures of distance between estimation errors and appropriate distance thresholds for those distance measures may also be used to determine when the performance of the supervised learning models has become unacceptable.

In response to determining that the performance has become unacceptable, the system modifies the current partitioning to add a new partition (step 312) and initializes a new supervised learning model that corresponds to the new partition (step 314).

In particular, the system modifies the current partitioning by adding a new centroid to the set of centroids that define the current partitioning using the estimation errors for the state representations in the sequence.

The system can determine the position of the new centroid in the space of possible RL input states in any of a variety of ways.

For example, the system can add the RL input state corresponding to the state representation having the highest estimation error as a new centroid to the set of centroids. That is, when the space of RL input states is the space of state representations, the RL input state corresponding to a given state representation in the sequence is the given state representation and when the space of RL input states is the space of possible state representation-action combinations, the RL input state corresponding to the given state representation is the combination of the given state representation and the action selected in response to the given state representation.

As another example, the system can identify each state representation in the sequence having an estimation error that exceeds a predetermined threshold value or a predetermined number of state representations in the sequence having the highest estimation errors and can determine the position of the new centroid from the RL input states corresponding to the identified state representations. For example, the new centroid can be the centroid of the RL input states corresponding to the identified state representations. As another example, the new centroid can be sampled from the RL input states corresponding to the identified state representations. As a further example, rather than use a predetermined threshold value, the system can identify each state representation having an estimation is more than a threshold number of standard deviations from the mean of the state representations in the sequence.

Generally, the system initializes the new supervised learning model by assigning initial parameter values to a model that has the same architecture as the supervised learning models that correspond to the partitions in the current partitioning. Generally, the system makes use of the current parameter values of the supervised learning models in the current partitioning. For example, the system can initialize the parameter values to be the same as the supervised learning model corresponding to the centroid that is closest to the new centroid. As another example, the system can initialize the parameter values to be a combination, e.g., an average, of the values of the parameters of the supervised learning models that correspond to the N closest centroid to the new centroids, where N is an integer greater than one.

After the current partitioning has been modified, the system repeats the process 300 with the modified partitioning in place of the current partitioning. The system can continue to repeat the process 300 until criteria for finalizing the partitioning have been satisfied, e.g., until the learning process has finished, until the performance of the supervised learning models has stayed acceptable for more than a threshold number of consecutive state representations or for more than a threshold time window, or until another suitable termination criterion has been satisfied.

In some implementations, the system may remove partitions from the partitioning during the learning process when certain removal criteria are satisfied. For example, the removal criteria may specify that the system should remove a given partition if the model corresponding to the partition has been unused, i.e., has not been the model used to generate the value function estimate for the selected action, for more than a threshold number of consecutive state representations.

FIG. 4 is a flow diagram of an example process 400 for determining an initial partitioning of a space of RL input states using imitation learning. For convenience, the process 400 will be described as being performed by a system of one or more computers located in one or more locations. For example, a reinforcement learning system, e.g., the reinforcement learning system 100 of FIG. 1, appropriately programmed, can perform the process 400.

The system obtains mentor interaction data (step 402). The mentor interaction data represents interactions by another entity, which may be referred to as the “mentor,” with the environment and returns resulting from those interactions. In particular, the mentor interaction data includes, for each action performed by the mentor, a state representation for the state of the environment when the action was performed and the return resulting from the action being performed.

The system trains a supervised learning model on the mentor interaction data (step 404) to adjust the values of the parameters of the supervised learning model. That is, the system generates training data for the supervised learning model by assigning as a label for each combination of action and state representation identified in the mentor interaction data the corresponding return and training the supervised learning model on the training data using conventional supervised learning techniques.

Once the supervised learning model has been trained, the system determines estimation errors for a set of combinations of action and state representations from the mentor action data using the trained supervised learning model (step 406). In particular, the system processes each combination of action and state representation in the set using the trained supervised learning model to determine a respective value function estimate for each combination. The system then determines an estimation error for the combination from the value function estimate for the combination and the actual return identified for the combination in the mentor interaction data.

The system uses an unsupervised learning technique to partition the RL input states corresponding to the combinations in the set in accordance with the estimation error (step 408).

In particular, the system partitions the RL input states such that regions of the RL input state space that include RL input states corresponding to combinations with higher estimation errors will include a larger number of partitions than regions that include RL input states corresponding to combinations having relatively lower estimation errors.

For example, the system can apply a weighted winner-take-all algorithm to partition the RL input states. Such algorithm would attribute more importance to some inputs, i.e., some RL input states, over others, where importance can be represented by a weight associated with each input, with the weights being derived from the estimation errors so that RL input states with higher estimation errors have higher weights. By dividing the distance from an input to each of the centroids by the weight of said input, centroids would gravitate more to samples with higher weights. As a result, higher centroid density will be allocated to regions that have inputs with high weights. An example winner-take-all algorithm that may be modified to associate weights derived from estimation errors with inputs is described in Steven Young, Itamar Arel, Thomas P. Karnowski, Derek Rose, “A Fast and Stable Incremental Clustering Algorithm,” available at http://web.eecs.utk.edu/˜itamar/Papers/ITNG2010.pdf.

The system then considers the centroids of the partitions of the RL input states as the centroids in the initial partitioning of the space of RL input states.

The system initializes a respective supervised learning model for each partition in the initial partitioning (step 410). For example, the system can initialize as an identical instance of the initial supervised learning model, e.g., each new supervised learning model can be initialized to have the same parameter values as the initial supervised learning model.

Once the initial partitioning has been determined and the corresponding models initialized, the system can adjust the partitioning as described above with reference to FIG. 3 until the final partitioning of the space has been determined.

The above description describes using supervised learning models that are configured to receive a state representation and an action and to generate a value function estimate for the state representation-action pair to select actions to be performed by the agent interacting with the environment. In some other implementations, however, the system instead uses state value supervised learning models that are configured to receive a state representation representing a given state and to generate a state value estimate that is an estimate of the long-term value of the environment having transitioned into the given state, e.g., of the return received starting from the environment being in the state. For example, the system can use these state value supervised learning models in conjunction with a transition model that receives a state and an action as input and predicts a state that is most likely to be the state the environment transitions into as a result of the actor performing the action in response to the given state representation to select the action to be performed by the agent. These state value supervised learning models can each correspond to a respective partition of the space of possible state representations as described above and the system can select actions using the state value supervised learning models and determine the final partitioning of the space of possible state representations as described above with reference to FIGS. 1-4.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of selecting an action to be performed by a computer-implemented agent that interacts with an environment by performing actions selected from a set of actions, the method comprising:
maintaining data defining a plurality of partitions of a space of reinforcement learning (RL) input states, each partition corresponding to a respective supervised learning model that is configured to receive a state representation and an action from the set of actions and to process the received state representation and the received action to generate a respective value function estimate that is an estimate of a return resulting from the computer-implemented agent performing the received action in response to the received state representation;
obtaining a current state representation that represents a current state of the environment;
for the current state representation and for each action in the set of actions, identifying a respective partition and processing the action and the current state representation using the supervised learning model that corresponds to the respective partition to generate a respective current value function estimate; and
selecting an action to be performed by the computer-implemented agent in response to the current state representation using the respective current value function estimates.

2. The method of claim 1, wherein the space of RL input states is a space of possible state representations.

3. The method of claim 2, wherein, for the current state representation and for each action in the set of actions, identifying the respective partition comprises determining the partition to which the current state representation belongs and identifying the partition to which the current state representation belongs as the partition for each of the actions in the set of actions.

4. The method of claim 1, wherein the space of RL input states is a space of possible combinations of possible state representations and an action in the set of actions.

5. The method of claim 4, wherein for the current state representation and for each action in the set of actions, identifying the respective partition comprises: determining a partition to which a combination of the current state representation and the action belongs.

6. The method of claim 1, wherein the data defining the plurality of partitions is data identifying a plurality of centroids, wherein each centroid is a point in the space of RL input states, and wherein each centroid defines a respective partition that includes each RL input state that is closer to the centroid than to any other centroid in the plurality of centroids.

7. The method of claim 6, wherein identifying a partition for an RL input state comprises determining the centroid that is closest to the RL input state of any of the plurality of centroids.

8. The method of claim 1, wherein obtaining the current state representation comprises:
receiving a current observation characterizing the current state of the environment; and
deriving the current state representation from the current observation.

9. The method of claim 1, wherein selecting an action to be performed by the computer-implemented agent in response to the current state representation using the respective current value function estimates comprises:
selecting an action having a highest current value function estimate.

10. The method of claim 1, wherein selecting an action to be performed by the computer-implemented agent in response to the current state representation using the respective current value function estimates comprises:
selecting an action other than an action having the highest current value function estimate.

11. The method of claim 1, wherein selecting an action to be performed by the computer-implemented agent in response to the current state representation using the respective current value function estimates comprises:
adjusting the value function estimates prior to selecting the action.

12. A method of determining a final partitioning of a space of reinforcement learning (RL) input states, each partition in the final partitioning corresponding to a respective supervised learning model of a plurality of supervised learning models that is configured to receive a state representation and an action from a set of actions and generate a respective value function estimate, the method comprising:
obtaining data defining a current partitioning of the space of RL input states, each partition in the current partitioning corresponding to a respective supervised learning model of the plurality of supervised learning models;
obtaining a sequence of state representations representing states of an environment and, for each state representation in the sequence, an action selected to be performed by the computer-implemented agent in response to the state representation and a value function estimate, the value function estimate being an estimate of a return resulting from a computer-implemented agent performing the selected action in response to the state representation;
obtaining, for each state representation in the sequence, an actual return resulting from the computer-implemented agent performing the selected action;
determining, from the actual returns and the value function estimates, that a performance of the plurality of supervised learning models has become unacceptable as of a particular state representation in the sequence and, in response:
modifying the current partitioning of the space of RL input states to add a new partition; and
initializing a new supervised learning model that corresponds to the new partition.

13. The method of claim 12, wherein the space of RL input states is a space of possible state representations.

14. The method of claim 12, wherein the space of RL input states is a space of possible combinations of possible state representations and an action in the set of actions.

15. The method of claim 12, wherein determining, from the actual returns and the value function estimates, that the performance of the plurality of supervised learning models has become unacceptable comprises:
determining, for each state representation, a respective estimation error from the actual return for the state representation and the value function estimate for the state representation; and
determining that the performance of the plurality of supervised learning models has become unacceptable based on the estimation errors.

16. The method of claim 15, wherein the data defining the current partitioning is data identifying a plurality of centroids, wherein each centroid is a point in the space of RL input states, and wherein each centroid defines a respective partition that includes each RL input state that is closer to the centroid than to any other centroid in the plurality of centroids.

17. The method of claim 16, wherein modifying the current partitioning of the space of RL input states comprises:
adding a new centroid to the plurality of centroids.

18. The method of claim 17, wherein adding the new centroid comprises:
determining a position of the new centroid in the space of possible RL input states from the estimation errors for the state representations in the sequence.

19. The method of claim 16, wherein initializing a new supervised learning model that corresponds to the new partition comprises:
initializing values of parameters of the new supervised learning model from values of parameters of supervised learning models corresponding to one or more closest centroids to the new centroid.

20. The method of claim 12, further comprising:
generating an initial partitioning of the space of RL input states by generating a predetermined number of partitions of the space of RL input states.

21. The method of claim 12, further comprising:
generating an initial partitioning of the space of RL input states, comprising:
obtaining mentor interaction data that represents interactions by another entity with the environment and returns resulting from those interactions;
training an initial supervised learning model on the mentor interaction data;
determining estimation errors for each of a plurality of combinations of actions and state representations from the mentor interaction data using the trained initial supervised learning model; and
partitioning the RL input states corresponding to the combinations in the plurality of combinations in accordance with the estimation errors.

22. The method of claim 21, wherein partitioning the RL input states corresponding to the combinations in the plurality of combinations in accordance with the estimation error comprises:
partitioning the RL input states corresponding to the combinations in plurality of combinations in accordance with the estimation error using an unsupervised learning technique.

23. The method of claim 22, wherein the unsupervised learning technique is a weighted clustering technique.

24. The method of claim 23, wherein the weighted clustering technique is a weighted winner-take-all clustering algorithm.

25. A system comprising one or more computers and one or more storage devices storing instructions that, when executed by the one or more computers, cause the one or more computers to perform operations for selecting an action to be performed by a computer-implemented agent that interacts with an environment by performing actions selected from a set of actions, the operations comprising:
maintaining data defining a plurality of partitions of a space of reinforcement learning (RL) input states, each partition corresponding to a respective supervised learning model that is configured to receive a state representation and an action from the set of actions and to process the received state representation and the received action to generate a respective value function estimate that is an estimate of a return resulting from the computer-implemented agent performing the received action in response to the received state representation;
obtaining a current state representation that represents a current state of the environment;
for the current state representation and for each action in the set of actions, identifying a respective partition and processing the action and the current state representation using the supervised learning model that corresponds to the respective partition to generate a respective current value function estimate; and
selecting an action to be performed by the computer-implemented agent in response to the current state representation using the respective current value function estimates.

26. The system of claim 25, wherein the data defining the plurality of partitions is data identifying a plurality of centroids, wherein each centroid is a point in the space of RL input states, and wherein each centroid defines a respective partition that includes each RL input state that is closer to the centroid than to any other centroid in the plurality of centroids.

27. The system of claim 26, wherein identifying a partition for an RL input state comprises determining the centroid that is closest to the RL input state of any of the plurality of centroids.

28. A system comprising one or more computers and one or more storage devices storing instructions that, when executed by the one or more computers, cause the one or more computers to perform operations determining a final partitioning of a space of reinforcement learning (RL) input states, each partition in the final partitioning corresponding to a respective supervised learning model of a plurality of supervised learning models that is configured to receive a state representation and an action from a set of actions and generate a respective value function estimate, the operations comprising:
obtaining data defining a current partitioning of the space of RL input states, each partition in the current partitioning corresponding to a respective supervised learning model of the plurality of supervised learning models;
obtaining a sequence of state representations representing states of an environment and, for each state representation in the sequence, an action selected to be performed by the computer-implemented agent in response to the state representation and a value function estimate, the value function estimate being an estimate of a return resulting from a computer-implemented agent performing the selected action in response to the state representation;
obtaining, for each state representation in the sequence, an actual return resulting from the computer-implemented agent performing the selected action;
determining, from the actual returns and the value function estimates, that a performance of the plurality of supervised learning models has become unacceptable as of a particular state representation in the sequence and, in response:
modifying the current partitioning of the space of RL input states to add a new partition; and
initializing a new supervised learning model that corresponds to the new partition.

29. The system of claim 28, wherein determining, from the actual returns and the value function estimates, that the performance of the plurality of supervised learning models has become unacceptable comprises:
determining, for each state representation, a respective estimation error from the actual return for the state representation and the value function estimate for the state representation; and
determining that the performance of the plurality of supervised learning models has become unacceptable based on the estimation errors.

30. The system of claim 29, wherein the data defining the current partitioning is data identifying a plurality of centroids, wherein each centroid is a point in the space of RL input states, and wherein each centroid defines a respective partition that includes each RL input state that is closer to the centroid than to any other centroid in the plurality of centroids.
